(19) United States
(12) Patent Application Publication
(10) Pub. No.: US 2015/0362196 A1
(43) Pub. Date: Dec. 17, 2015

(54) BAFFLE ASSEMBLY FOR VENTILATOR HOOD

(71) Applicant: Foremost Groups, Inc., East Hanover, NJ (US)

(72) Inventors: Joe Chen, Randolf, NJ (US); Michael Paitchell, Clifton, NJ (US)

(73) Assignee: Foremost Groups, Inc., East Hanover, NJ (US)

(21) Appl. No.: 14/725,859

(22) Filed: May 29, 2015

Related U.S. Application Data
(60) Provisional application No. 62/012,611, filed on Jun. 16, 2014.

(51) Int. Cl. F24C 15/20; B01D 45/08

(52) U.S. Cl. CPC F24C 15/2035; B01D 45/08

(57) ABSTRACT

A baffle filter for a ventilator has first and second frames with end and side walls, face to face and releasably attached. First and second baffles are mounted in the first and second frames, parallel and spaced apart. Each baffle has a base and two sides forming a U shaped channel open towards the other frame. The sides of each second baffle are angled towards the first frame and away from each other. The second and first baffles overlap and alternate to define serpentine paths into the filter between two first baffles, into the channel of a second baffle, back between the second baffle and one of those two first baffles, into the channel defined by that first baffle, and out between that second baffle and an adjacent second baffle. The channels of the first baffles extend toward drain holes in an end wall of the first frame.

### RELATED APPLICATION

This application claims priority to U.S. Provisional Application No. 62/012,611 filed on Jun. 16, 2014, the disclosure of which is incorporated herein by reference in its entirety.

### FIELD OF THE INVENTION

The present invention relates to ventilator hoods and, more particularly, to an improved baffle assembly for catching grease in a ventilator hood assembly.

### BACKGROUND

When cooking on a stove, significant amounts of grease may be released into the air. When a ventilator or extractor fan is used to remove air from above the stove through an exhaust duct, the grease may be drawn into the ventilator system. This may result in a build-up of grease in the exhaust duct, and/or the discharge of grease through an outlet of the exhaust duct, with undesirable effects in either case.

### SUMMARY

According to an aspect of the invention, there is provided a baffle filter for a ventilator, comprising a first frame having two end walls and two side walls, a second frame face to face with the first frame and releasably attached to the first frame, the second frame having two end walls and two side walls, a plurality of first baffles, generally parallel to and spaced apart from one another, mounted in the first frame, each first baffle comprising a base and two sides forming a generally U shape, each first baffle defining a channel open towards the second frame, the first baffles extending substantially parallel to the side walls of the first frame, a plurality of second baffles, generally parallel to one another and to the first baffles and spaced apart from one another, mounted in the second frame, each second baffle comprising a base and two sides, the sides of each second baffle angled towards the first frame and away from each other, each second baffle defining a channel open towards the first frame, the second baffles extending substantially parallel to the side walls of the second frame, the second baffles and the first baffles overlapping and alternating so as to define serpentine air flow paths extending into the filter between two adjacent ones of the first baffles and into the channel defined by one of the second baffles, back between one of the sides of said one of the second baffles and one of the sides of one of said two adjacent ones of the first baffles and into the channel defined by said one of the first baffles, and out of the filter between said one of the second baffles and an adjacent one of the second baffles; and drain holes formed in at least one end wall of the first frame, the channels of the first baffles extending toward the drain holes.

In an embodiment, the sides of each first baffle may be bent to form proximal portions angled towards the second frame and away from each other and distal portions angled towards the second frame and towards each other. Alternatively, the sides of each first baffle may be curved so that portions nearest the base curve towards the second frame and away from each other and portions furthest from the base curve towards the second frame and towards each other. In an embodiment, the baffle filter further comprises at least one additional baffle, comprising a base joined to a side wall of the first frame or the second frame and one side wall, and defining an additional serpentine flow path with an outermost one of said first baffles and an outermost one of said second baffles.

In an embodiment, free edges of the sides of the first baffles and free edges of the sides of the second baffles are generally coplanar.

According to another aspect, a baffle filter assembly for a ventilator comprises a housing defining an opening; and a baffle filter according to any of the mentioned aspects and embodiments. The baffle filter is positioned across the opening with the second frame above the first frame and an end wall having the drain holes lower than an opposite end wall, and a receptacle for flowable materials under the drain holes outside the baffle filter.

In an embodiment, the receptacle for flowable materials may comprise an elongate trough extending along said end wall, further comprising a transverse member extending across the elongate trough and supporting an end of the baffle filter comprising said end wall.

In an embodiment, the baffle filter may occupy substantially an entire area of the opening. In an alternative embodiment, there is at least one additional baffle filter according to any of the mentioned aspects and embodiments, and both or all of the filter may then together occupy substantially an entire area of the opening in the housing.

In an embodiment, the assembly may further comprise a ventilator operative to draw air upwards through the opening in the housing.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a perspective view of a baffle assembly according to the present invention for use in a ventilator hood.

FIG. 2 is a perspective view of the reverse side of the baffle assembly of FIG. 1 with an optional charcoal filter kit.

FIG. 3 is a perspective view of the baffle assembly of FIG. 1 installed in a ventilator hood.

FIG. 4 is a perspective view of the baffle assembly of FIG. 1 disassembled for cleaning.

FIG. 5A is a bottom view of the baffle assembly of FIG. 1.

FIG. 5B is a cross-sectional view of the baffle assembly of FIG. 5A taken along line 5B-5B.

FIG. 5C is a top view of the baffle assembly of FIG. 5A.

FIG. 6A is a side schematic view of the baffle assembly of FIG. 1 installed in an embodiment of a ventilator hood assembly.

FIG. 6B is a side schematic view of the baffle assembly of FIG. 6A in the process of being removed from or installed into the ventilator hood assembly.

FIG. 7A is a bottom view of the ventilator hood assembly of FIG. 6A with three baffle assemblies of FIG. 1 mounted adjacent to one another.

FIG. 7B is a cross-sectional view of the ventilator hood assembly in FIG. 7A taken along line 7B-7B.

FIG. 8 is an enlarged portion of the cross-section of the baffle assembly of FIG. 5B illustrating the airflows and capture of grease.

FIG. 9A is a top view of an embodiment of a drainage trough.

FIG. 9B is a cross-sectional view of the drainage trough in FIG. 9A taken along line 9B-9B.

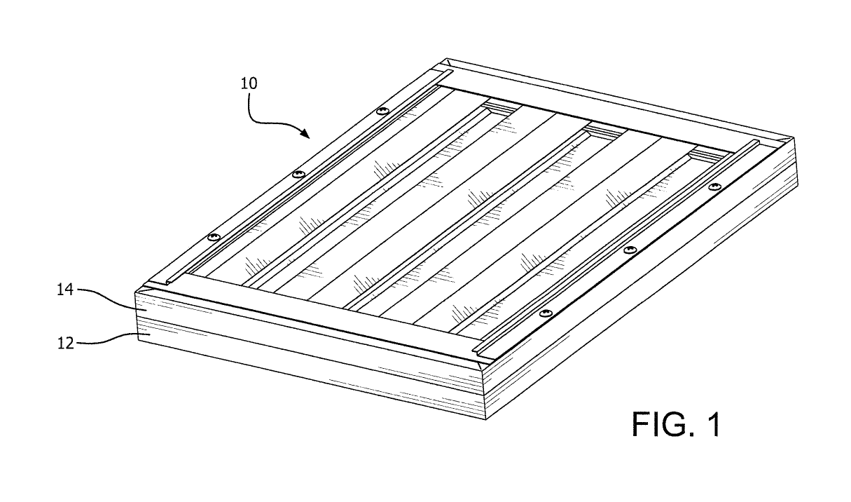

### DETAILED DESCRIPTION OF THE EMBODIMENTS

Referring to the drawings, an embodiment of a baffle assembly 10 as presently preferred is illustrated. The baffle assembly 10 includes a lower baffle section 12 and an upper baffle section 14 that are removably attached to one another. The lower baffle section 12 includes a frame 16 and a plurality of linear spaced apart lower baffle channels 18 that are secured to the frame 16, such as through fasteners, welding or brazing. The channels 18 could be removably secured to the frame 16, such as through the use of clips. The channels 18 have an open side 20 that faces toward the back of the lower baffle section 12 (i.e., to the upper baffle section 14). The spacing 22 between the channels 18 defines open areas for air to flow from one side of the lower baffle section to the other as will be discussed in more detail below. In the illustrated embodiment, each lower baffle channel 18 has a base wall 18A and two curved or bent side walls 18B extending away from the base wall 18A so as to form a substantially U-shaped cross section. The lower baffle channel 18 is designed to capture and provide a conduit for grease that is released from the passing airstream. The curved or bent side walls 18B are configured to facilitate insertion and removal of the baffle assembly by providing a comfortable contour for a user to grasp. Since during use the lower baffle channels 18 will likely have some grease or other captured contaminants on their outer surface, providing a contoured outer surface of the channel 18 permits a user to grasp the channel firmly when removing the baffle assembly 10 without risk of being cut.

The frame 16 includes sidewalls 16A preferably on all four sides of the lower baffle section 12. At least one drainage hole 19 is formed in at least one sidewall 16A so as to permit drainage from the lower baffle channels 18. More preferably there is a drainage hole 19 associated with each lower baffle channel 18 and in close proximity to the base wall 18A.

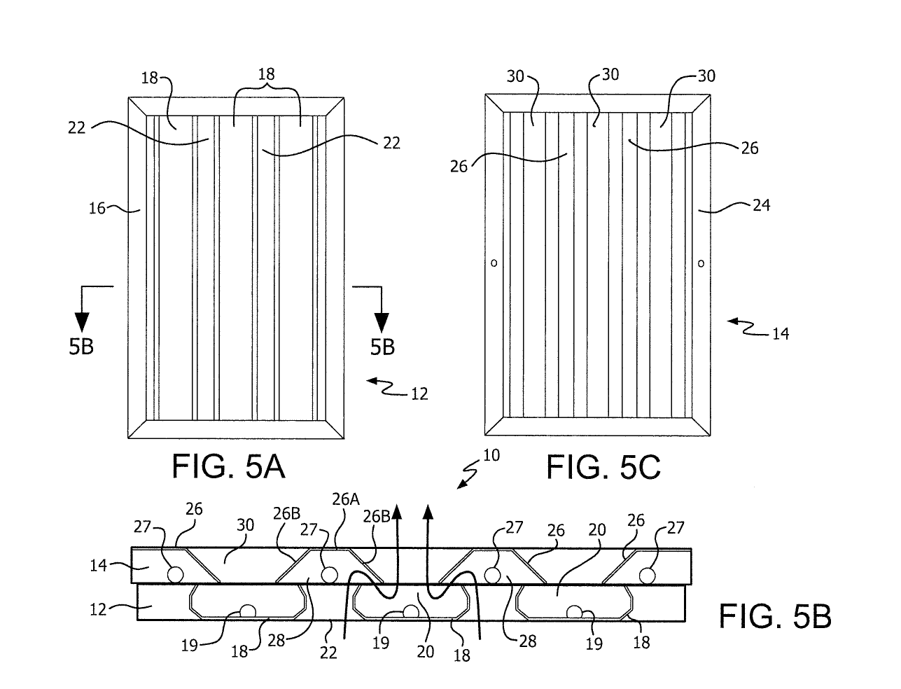

The upper baffle section 14 is similar to the lower baffle assembly 12 and includes a frame 24 and a plurality of linear spaced apart upper baffle channels 26 that are secured to the frame 24, such as through fasteners, welding or brazing, or could be removable attached. Each upper baffle channel 26 has a base wall 26A with one or more sloping side walls 26B extending outwardly away from the base wall so as to form a substantially straight walled U-shaped channel. It is noted that the baffle channels closest to the frame 24 may form a portion of a U-shaped channel the other side of which is formed by the frame, as shown in FIG. 5B. The open side 28 of the channel faces toward the front of the upper baffle section 14 (i.e., toward the lower baffle section 12). The spacing 30 between the channels defines open areas for air to flow from one side of the baffle section to the other for directing the air flow as will be discussed below.

The frame 24 includes sidewalls 24A preferably on all four sides of the upper baffle section 14. At least one drainage hole 27 is formed in at least one sidewall 24A so as to permit drainage from the upper baffle channels 26. More preferably, there is a drainage hole 27 associated with each upper baffle channel 26 and away from the base 26A as shown in FIG. 5B.

The mounting and spacing of the upper baffle channels 26 to the frame 24 is such that that open side 28 of each upper baffle channel 26 is positioned so as to be aligned with the spacing 22 between the lower baffle channels 18 in the lower baffle section 12. This configuration results in the spacings between the lower and upper baffle sections defining a serpentine flow path though the baffle assembly 10 as illustrated by the arrows in FIG. 5B.

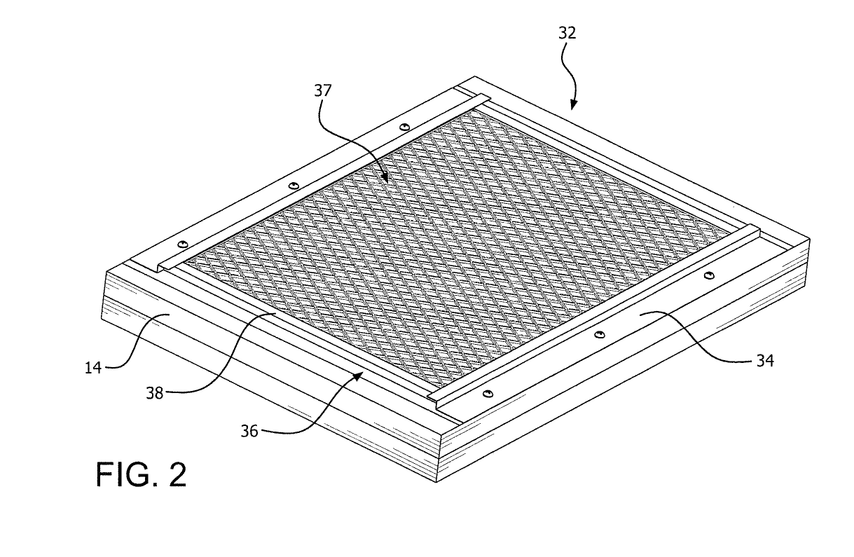

As shown in FIG. 2, an optional charcoal filter assembly 32 may be included. the filter assembly 32 includes a bracket 34 that is attached to the rear face (the top) of the upper baffle section 14. The bracket 34 is designed to removably secure a charcoal filter 36 to the top (exhaust side) of the upper baffle section 14. In the illustrated embodiment, the bracket includes three flanges that define an open slot on the side for the charcoal filter to slide into. The charcoal filter 36 includes a charcoal filter media 37 mounted within a metal or plastic frame 38. The bracket 34 can be attached to the upper baffle section 14 through any conventional means, including through use of one or more screws.

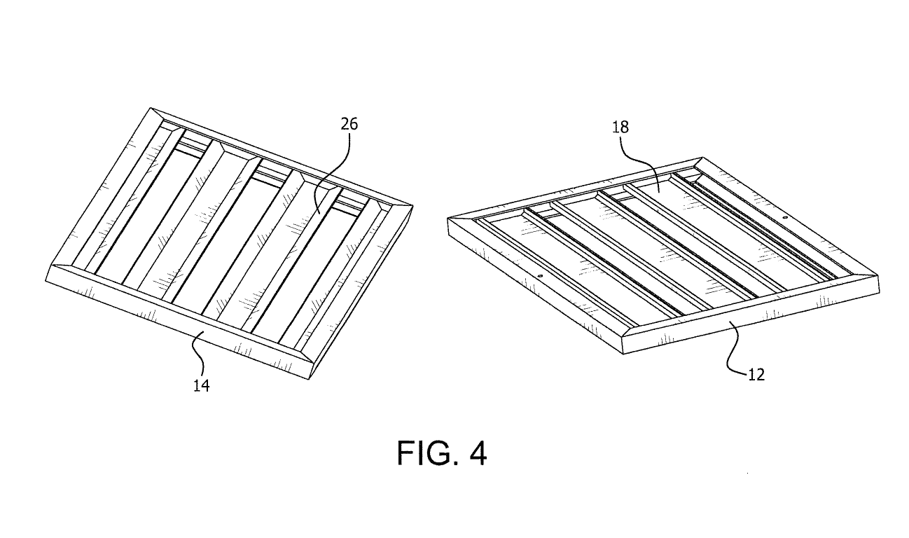

As discussed above, the lower baffle section and upper baffle section are removably attached to one another. The removable attachment can be through various mechanisms, such as thumb screws, quarter-turn fasteners, clamps, for example, so as to permit a user to separate the two sections 12, 14 without the need for tools. It is also contemplated that one of the sections 12, 14 may include a bracket similar to the charcoal filter bracket 34 which is sized to receive the other section 12, 14, thus permitting one section to be slid into engagement with the other. The separation of the baffle sections 12, 14 permits the two baffle sections to be easily cleaned. FIG. 4 illustrates the baffles separated from one another. Preferably the baffle sections 12, 14 are made from a material that is capable of withstanding moisture and heat without deteriorating, such as stainless steel or high temperature plastic. The material is preferably selected to be dishwasher safe so that the separate sections can be placed into a dishwasher for cleaning.

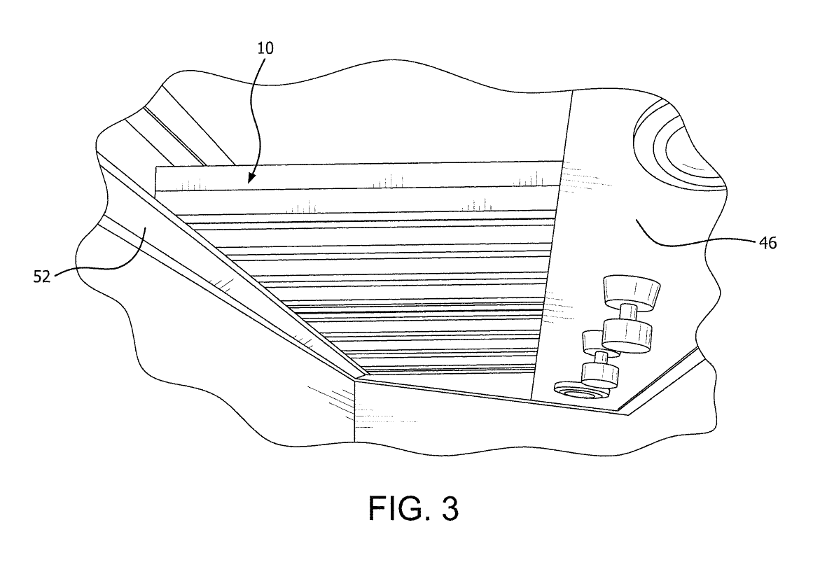

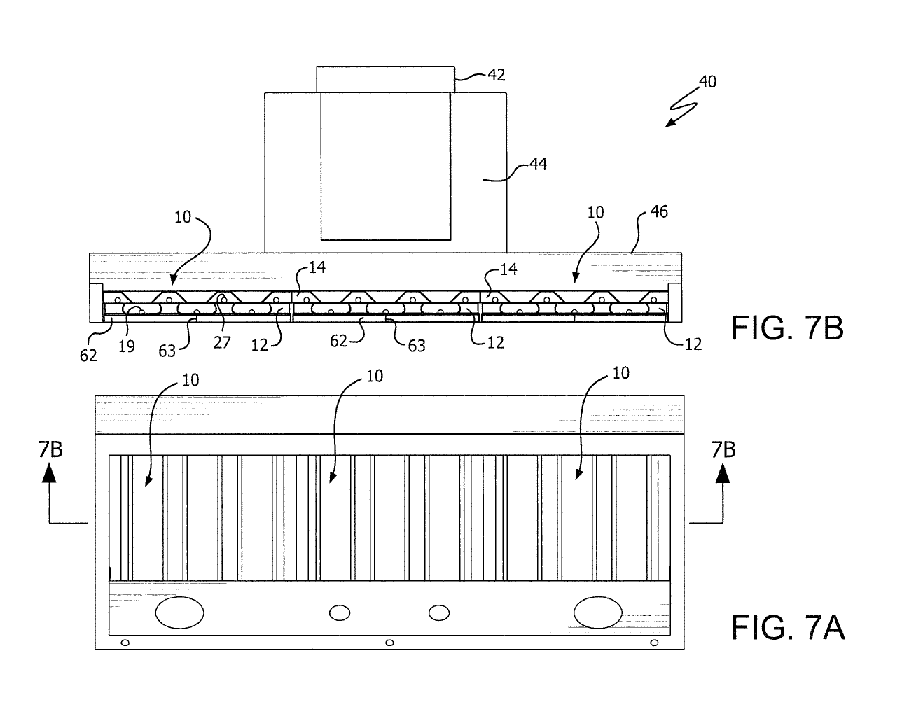

Referring to FIGS. 3, 7A and 7B, the baffle assembly 10 is shown mounted to the bottom of a ventilator hood assembly 40. The ventilator hood assembly 40 includes an exhaust duct 42, a blower assembly 44 and a hood 46. In the illustrated embodiment there are preferably multiple baffle assemblies 10 mounted to the hood 46 adjacent to one another.

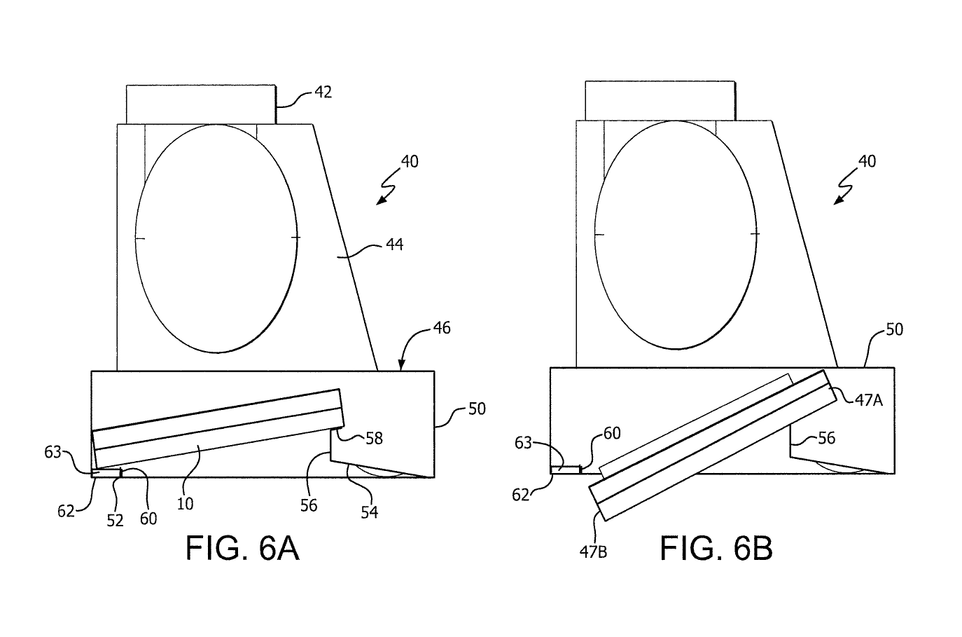

Referring to FIGS. 6A and 6B, the mounting of the baffle assembly 10 to the cooktop hood 46 is shown in one embodiment. The hood 46 includes a housing 50 with a rear bracket 52 and a front bracket 54. The front bracket 54 includes a flange 56 that extends upward into the housing 50 and terminates at a lip 58. The rear bracket 52 also has a vertical flange 60 that extends into the housing 50. As shown, the upper end of the vertical flange 60 of the rear bracket 52 is located below the upper end of the vertical flange 56 and lip 58 of the front bracket 54. The vertical flange 60 of the rear bracket 52 is designed to contain one or more removable drainage troughs 62.

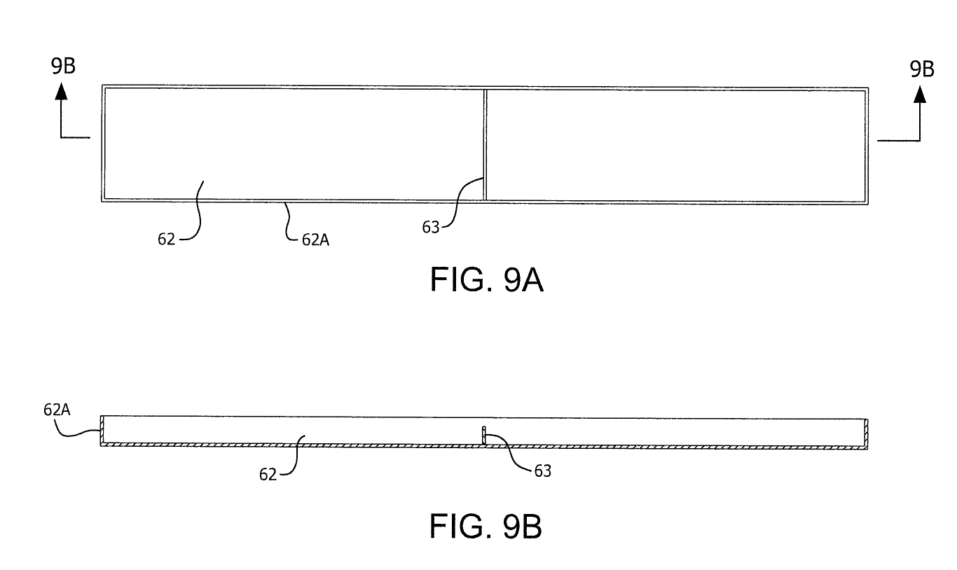

The removable drainage trough 62 is shown in detail in FIGS. 9A and 9B. The trough includes a bottom and four sidewalls 62A for capturing grease and other contaminants. A center rib 63 extends at least partially between the two long sidewalls and is shorter than the sidewalls 62A.

The baffle assembly 10 is installed on the hood 46 by inserting a first side edge 47A of the baffle assembly into the opening on the bottom of the hood 46 as shown, and sliding it upward and forward until a second side edge 47B of the baffle assembly 10 (opposite from the first side edge 47A) clears the rear bracket 52 as shown in FIG. 6B. The second side edge 47B is then moved upwards until it clears the top of the vertical flange 60 and the top of the sidewall 62A of the drainage trough 62. The baffle assembly 10 is then slid backwards until the back edge of the frame 16 of the lower baffle section 12 sits on the center rib 63 of the drainage trough 62. As should be apparent from the figures, the height difference between the flange 56 and the center rib 63 results in the baffle assembly 10 resting at an angle tilted rearward and downward toward the back of the hood 46. This angle is designed to cause grease that is captured by the baffle assembly 10 to drain down the lower baffle channels 18 and out of the drainage holes 19, and down the upper baffle channels 26 and out of the drainage holes 27. The height of the center rib 63 prevents the flange 60 of the rear bracket 52 and the sidewall 62A from blocking the drainage of the grease. As shown in FIG. 7B, the drainage trough 62 extends perpendicular to the orientation of the channels 18 so as to capture all the grease being drained. In the illustrated embodiment, the drainage trough 62 is slightly larger than the width of the lower baffle section 12 of a single baffle assembly 10, so that the lower baffle section 12 fits between the sidewalls 62A. As such, if there are multiple baffle assemblies 10 in the hood assembly 40, then there would be a drainage trough 62 associated with each baffle assembly 10. However, it is also contemplated that the drainage trough 62 may extend the width of the several or all of the baffle assemblies 10. By making the drainage trough removable, it can be easily cleaned by the user.

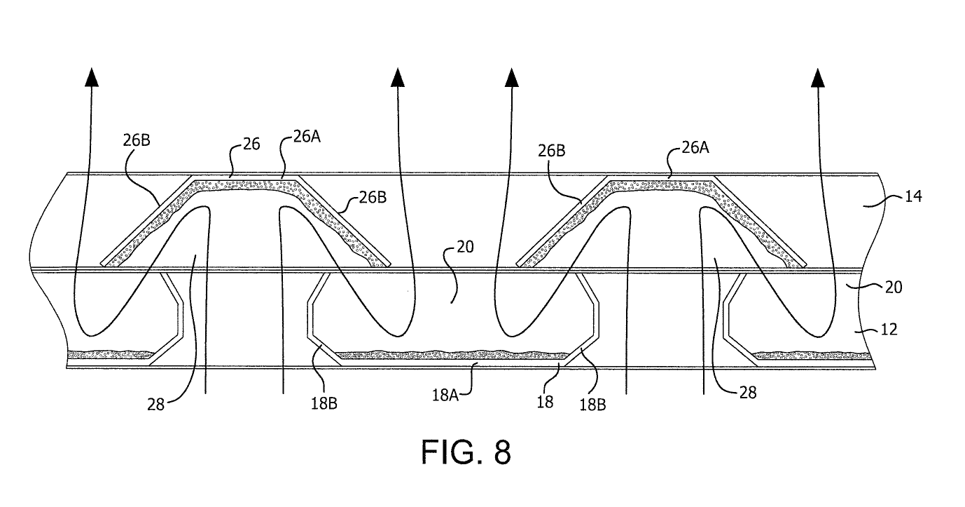

Referring to FIG. 8, as discussed above, the channels in the upper and lower baffle sections are designed to direct and capture grease that is entrapped within the air stream as it is being exhausted. During use, when the motor assembly 44 is activated, a negative pressure (vacuum) is created along the top of the upper baffle section 14. This causes air from the cooktop to be drawn first through the spacing 22 between the lower baffle channels 18 and into the open side 28 of the upper baffle channels 26. The grease laden air hits the base 26A of the upper baffle channel 26 and is then directed to the lower baffle channel 18, contacting its base 18A. Due to surface tension and the physical properties of the grease, the grease is retained on bases 26A and 18A as the air continues to flow as shown in the figure by the solid arrow. As the grease builds up on channel 26, gravity and the pressure caused by the flowing air will cause the grease to slide along the side walls 26B of the upper baffle channel. This is shown by the stippling in FIG. 8. The grease will eventually drain down onto the base 18A of the lower baffle channel 18 where it will collect. As discussed above, the baffle assembly 10 is mounted on an angle in the hood 46. As such, the grease will flow along the base 18A of the lower baffle channel 18 to the drainage holes 19. Once the grease reaches the holes 19, the grease will drain into the drainage trough 62.

In the interests of clarity, the embodiment has been described with reference to an ordinary orientation in use. However, the baffle assembly may be stored and transported in any orientation, and could in some circumstances be used in an orientation other than that described, and terms of orientation should not be interpreted as excluding such other orientations.

1. A baffle filter for a ventilator, comprising:
a first frame having two end walls and two side walls;
a second frame face to face with the first frame and releasably attached to the first frame, the second frame having two end walls and two side walls;
a plurality of first baffles, generally parallel to and spaced apart from one another, mounted in the first frame, each first baffle comprising a base and two sides forming a generally U shape, each first baffle defining a channel open towards the second frame, the first baffles extending substantially parallel to the side walls of the first frame;
a plurality of second baffles, generally parallel to one another and to the first baffles and spaced apart from one another, mounted in the second frame, each second baffle comprising a base and two sides, the sides of each second baffle angled towards the first frame and away from each other, each second baffle defining a channel open towards the first frame, the second baffles extending substantially parallel to the side walls of the second frame;
the second baffles and the first baffles overlapping and alternating so as to define serpentine air flow paths extending into the filter between two adjacent ones of the first baffles and into the channel defined by one of the second baffles, back between one of the sides of said one of the second baffles and one of the sides of one of said two adjacent ones of the first baffles and into the channel defined by said one of the first baffles, and out of the filter between said one of the second baffles and an adjacent one of the second baffles; and
drain holes formed in at least one end wall of the first frame, the channels of the first baffles extending toward the drain holes.

2. The baffle filter for a ventilator according to claim 1, wherein the sides of each first baffle are bent to form proximal portions angled towards the second frame and away from each other and distal portions angled towards the second frame and towards each other.

3. The baffle filter for a ventilator according to claim 1, wherein the sides of each first baffle are curved so that portions nearest the base curve towards the second frame and away from each other and portions furthest from the base curve towards the second frame and towards each other.

4. The baffle filter for a ventilator according to claim 1, further comprising:
at least one additional baffle, comprising a base joined to a side wall of the first frame or the second frame and one side wall, and defining an additional serpentine flow path with an outermost one of said first baffles and an outermost one of said second baffles.

5. The baffle filter for a ventilator according to claim 1, wherein free edges of the sides of the first baffles and free edges of the sides of the second baffles are generally coplanar.

6. A baffle filter assembly for a ventilator, comprising:
a housing defining an opening;
a baffle filter comprising
a first frame having two end walls and two side walls;
a second frame face to face with the first frame and releasably attached to the first frame, the second frame having two end walls and two side walls;
a plurality of first baffles, generally parallel to and spaced apart from one another, mounted in the first frame, each first baffle comprising a base and two sides forming a generally U shape, each first baffle defining a channel open towards the second frame, the first baffles extending substantially parallel to the side walls of the first frame;
a plurality of second baffles, generally parallel to one another and to the first baffles and spaced apart from one another, mounted in the second frame, each second baffle comprising a base and two sides, the sides of each second baffle angled towards the first frame and away from each other, each second baffle defining a channel open towards the first frame, the second baffles extending substantially parallel to the side walls of the second frame;
the second baffles and the first baffles overlapping and alternating so as to define serpentine air flow paths extending into the filter between two adjacent ones of the first baffles and into the channel defined by one of the second baffles, back between one of the sides of said one of the second baffles and one of the sides of one of said two adjacent ones of the first baffles and into the channel defined by said one of the first baffles, and out of the filter between said one of the second baffles and an adjacent one of the second baffles; and
drain holes formed in at least one end wall of the first frame, the channels of the first baffles extending toward the drain holes;
the baffle filter being positioned across the opening with the second frame above the first frame and an end wall having the drain holes lower than an opposite end wall; and
a receptacle for flowable materials under the drain holes outside the baffle filter.

7. The assembly according to claim 6, wherein the receptacle for flowable materials comprises an elongate trough extending along said end wall, further comprising a transverse member extending across the elongate trough and supporting an end of the baffle filter comprising said end wall.

8. The assembly according to claim 6, wherein the baffle filter occupies substantially an entire area of the opening.

9. The assembly according to claim 6, further comprising at least one additional baffle filter comprising
a first frame having two end walls and two side walls;
a second frame face to face with the first frame and releasably attached to the first frame, the second frame having two end walls and two side walls;
a plurality of first baffles, generally parallel to and spaced apart from one another, mounted in the first frame, each first baffle comprising a base and two sides forming a generally U shape, each first baffle defining a channel open towards the second frame, the first baffles extending substantially parallel to the side walls of the first frame;
a plurality of second baffles, generally parallel to one another and to the first baffles and spaced apart from one another, mounted in the second frame, each second baffle comprising a base and two sides, the sides of each second baffle angled towards the first frame and away from each other, each second baffle defining a channel open towards the first frame, the second baffles extending substantially parallel to the side walls of the second frame;
the second baffles and the first baffles overlapping and alternating so as to define serpentine air flow paths extending into the filter between two adjacent ones of the first baffles and into the channel defined by one of the second baffles, back between one of the sides of said one of the second baffles and one of the sides of one of said two adjacent ones of the first baffles and into the channel defined by said one of the first baffles, and out of the filter between said one of the second baffles and an adjacent one of the second baffles; and
drain holes formed in at least one end wall of the first frame, the channels of the first baffles extending toward the drain holes;
wherein the at least one additional baffle filter is positioned across the opening with the second frame above the first frame and an end wall having the drain holes lower than an opposite end wall, and the receptacle for flowable materials under the drain holes outside the baffle filter; and
wherein the baffle filter and the at least one additional baffle filter together occupy substantially an entire area of the opening in the housing.

10. The assembly according to claim 6, further comprising a ventilator operative to draw air upwards through the opening in the housing.
